(19) United States
(12) Patent Application Publication
(10) Pub. No.: US 2011/0170443 A1
(43) Pub. Date: Jul. 14, 2011

(54) LINK SENSITIVE AODV FOR WIRELESS DATA TRANSFER

(76) Inventors: Ronald Gerald Murias, Calgary (CA); Rashed Haydar, Calgary (CA)

(21) Appl. No.: 13/006,381

(22) Filed: Jan. 13, 2011

Related U.S. Application Data
(60) Provisional application No. 61/308,289, filed on Feb. 25, 2010.
(60) Provisional application No. 61/294,559, filed on Jan. 13, 2010.

(51) Int. Cl. H04W 24/02

(52) U.S. Cl. 370/252

(57) ABSTRACT

A method of improving signal quality in an ad hoc on-demand distance vector (AODV) mesh network, comprising detecting at a node the signal quality of a received AODV protocol message, comparing the signal quality of the received AODV protocol message to a threshold; and on detecting that the signal quality of the received AODV message is not above the threshold, dropping the received AODV message. Further, a method of improving AODV mesh operation by detecting at a node the signal quality of the RREQ messages received at that node; and dropping any RREQ messages for which the signal quality is not above a threshold.

### CROSS-REFERENCE TO RELATED APPLICATIONS

This application claims the benefit under 35 U.S.C. §119(e) of U.S. Provisional Application No. 61/295,559, filed Jan. 13, 2010 and Application No. 61/308,289, filed Feb. 25, 2010.

### BACKGROUND

Conventional seismic data collection is performed through wired connections between the seismic sensors and the data collection and analysis equipment.

Wireless data collection offers more freedom for placement of sensors, allowing for more complex sensor pattern placement and easier deployment in rough terrain.

AODV (ad hoc on-demand distance vector) is a network routing protocol. It enables network nodes (usually a wireless mesh) to pass messages through neighbour nodes to reach nodes that would be otherwise out of range or cannot be reached. The path from a source to a destination is discovered by broadcasting a “route request” (RREQ) message, then waiting for a “route reply” (RREP) message.

The RREQ message contains the source of the message (originating node identifier), the destination of the message (node to be found), a lifespan value, and a sequence number. The lifespan value determines how long (without finding the destination node) the discovery process will continue, and the sequence number is used by the nodes in the network to determine the “freshness” of discovered paths.

When a node receives a RREQ message, that node does one of two things: if it knows a route to the destination, or if it is the destination, the node sends a RREP message back to the originating node. Otherwise, the node will re-broadcast the RREQ message to its neighbours. This continues until the destination node is found, or the lifespan of the RREQ message has expired.

One issue with wireless replacement of data collection cables using an AODV mesh is a fundamental issue regarding the selection of a path between two nodes that need to exchange data.

For an AODV network where it is common to find one node within good communication range of another but also within poor communication range of a third node, the original design of AODV does not take into account link quality and may result in a route that favors fewer hops with poor quality links over more hops with good quality links. In some cases, a link may be established (using the short, low data rate RREQ/RREP messages) that is unusable for regular data.

Furthermore, on many consumer grade devices, the precision of the signal measurement (e.g. SINR, RSSI, etc.) is poor. This can result in wide variations of the measured value, which can result in the system moving between PROCESSING state and DROPPING state often, which degrades the performance of the network, and leads to dropped packets and isolated nodes. Not only is the precision poor but also variability from unit to unit. There are also spurious jumps in the signal measurements due to instantaneous changes in the RF channel: for example a vehicle, animal or person passing between the units or beside them.

### SUMMARY

In an embodiment, there is provided a method of improving signal quality in an ad hoc on-demand distance vector (AODV) mesh network, comprising detecting at a node the signal quality of a received AODV protocol message, comparing the signal quality of the received AODV protocol message to a threshold; and on detecting that the signal quality of the received AODV message is not above the threshold, dropping the received AODV message.

In an ad hoc on-demand distance vector (AODV) mesh, there is also provided an improvement comprising: detecting at a node the signal quality of the RREQ messages received at that node; and dropping any RREQ messages for which the signal quality is not above a threshold.

In a further embodiment, there is provided a method of establishing a route with acceptable signal quality in a wireless mesh network, comprising transmitting at a first node a route request message that requests a route connecting to a second node; carrying out at least at a node at which the route request message is detected, the route request message being either the direct transmission from the first node or a retransmission from another node, the steps of: a) determining from which node the route request message was received at the node; b) determining whether the signal quality of the route request message is above a threshold; and c) retransmitting the route request message if the signal quality was determined in the previous step to be above the threshold, and dropping the route request message if the signal quality was determined in the previous step not to be above the threshold; receiving at the second node the route request message; transmitting a reply message from the second node to the first node; on detecting at the second node the route request message, sending a reply message indicating that a route has been found to the node from which the route request message was received at the second node; at the node from which the route request message was received at the second node, if that node is not the first node, retransmitting the reply message indicating that a route has been found to the node from which the route request message was received at that node; and repeating the previous step until the reply message indicating that a route has been found is received at the first node.

In a further embodiment, there is provided a method of establishing routing tables for improving signal quality in a wireless mesh network, comprising transmitting a message from a first node; detecting and measuring the signal quality of the message at a second node; comparing the signal quality of the message to a threshold; and updating a routing table at the second node so that the routing table includes the first node as a neighbor node only if the signal quality of the message is above the threshold.

In a further embodiment there is method of improving signal quality in a wireless mesh network, comprising: detecting at a first node a signal quality of a transmission from a second node; comparing the signal quality of the transmission to a threshold; and allowing the link between the first node and the second node to be used in a route only if the signal quality is above the threshold, in which the threshold is varied at the first node depending on at least one of A) the number of other nodes the signal quality from which has been detected at the first node to be above the threshold, and B) the load transmitted by the first node.

To resolve the issue of signal variability, reported signal quality measurements of incoming packets may be filtered before threshold/hysteresis processing. Signal averaging, median filtering, and other smoothing or low pass filtering methods improved link stability and the quality of the network.

### BRIEF DESCRIPTION OF THE FIGURES

There will now be described embodiments having regard to the drawings by way of example, in which:

FIG. 1 is a schematic of a simplified prior art network;

FIG. 2 is a schematic of a further prior art network;

FIG. 3 is a flow diagram illustrating an embodiment of a method of improving signal quality in an AODV network;

FIG. 4 is a diagram showing a message sequence for a HELLO/ACK exchange;

FIG. 5 is a diagram showing a decision mechanism for receiving a message;

FIG. 6 shows an apparatus for carrying a method of improving signal quality in an AODV network; and

FIG. 7 shows a state machine for the apparatus of FIG. 6 accounting for hysteresis.

### DETAILED DESCRIPTION

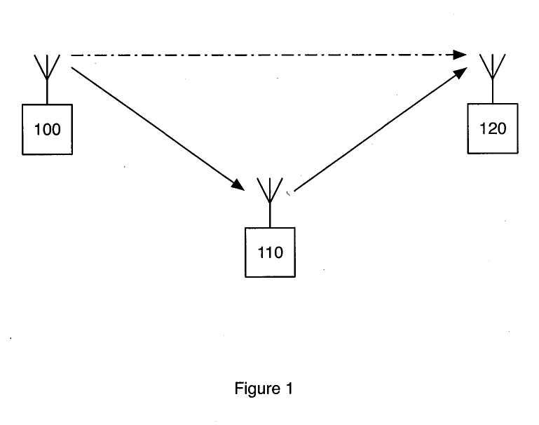

FIG. 1 shows the simple 3-node case where node 100 is discovering a route to node 120. The solid arrows represent a strong radio link, and the dotted arrow represents a weak radio link. In this case, an RREP would be transmitted from 120 back to 100, resulting in a poor radio link for data communication.

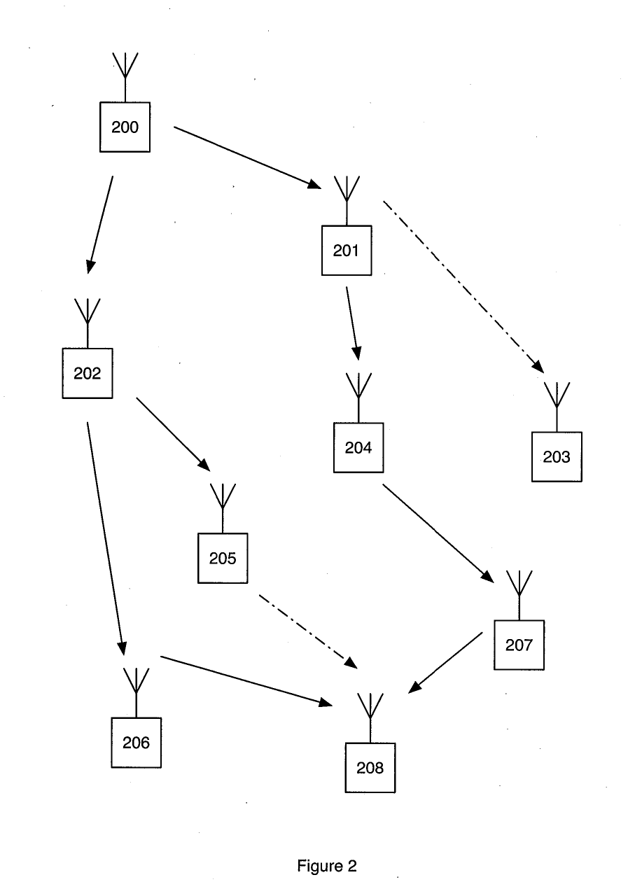

FIG. 2 shows a more complete mesh with two poor links: one in the middle of a path from 200 to 208, and another poor link to the destination node, 208, from an intermediate node, 205. Node 200 is attempting to find a path to node 208.

In order to compensate for poor links in AODV networks, when receiving an RREQ message, each node compares the signal quality of the incoming message to a stored threshold value. If the signal quality does not meet or exceed the threshold value, the node drops the RREQ without responding or forwarding the packet. This way, weak links are not used for any data transmission, and stronger, multi-hop links are enforced.

Any combination of input SNR (signal-to-noise ratio), SINR (signal-to-noise-plus-interference ratio), CINR (carrier-to-noise-plus-interference ratio), RSSI (received signal strength indicator), and/or other similar parameter may be used as a parameter against which the threshold value is compared. Another test may be a parameter related to link quality, for example, the modulation/coding scheme selected by the transmitting device. If a low modulation/coding rate were used to transmit, this may indicate that the link is poor and the transmitter had to reduce the rate in order to complete the transmission.

Referring back to FIG. 1, with traditional AODV, an RREP message would be transmitted from 120 back to 100, resulting in a poor radio link for data communication. Using the threshold disclosed here, the RREQ message received by 120 from 100 would be dropped, while 120 would respond (with a RREP message) to the RREQ message received from 110, resulting in a good quality two-hop connection.

In FIG. 2, the RREQ message received by 203 from 201 would be dropped, and 203 does not forward the REQ message to 207, nor does it respond through 201. Also, the RREQ message from 205 to 208 is dropped, and the data packet path will likely be 200-202-206-208 (depending on response times and AODV settings).

In some cases, the link between two nodes may not be symmetric. In this case, a node may receive the RREQ message with good signal quality, but the RREP message, going in the opposite direction, may be of poor quality. In this case, the node receiving the RREP message drops the message and transmits an RERR message. This will also result in the removal of the attempted route from the list of possible routes from the originator to the destination. The node transmitting the RREP message will also receive this RERR message and can use it to update its tables (it now knows that, although the receive link looks okay, the transmit path is not acceptable).

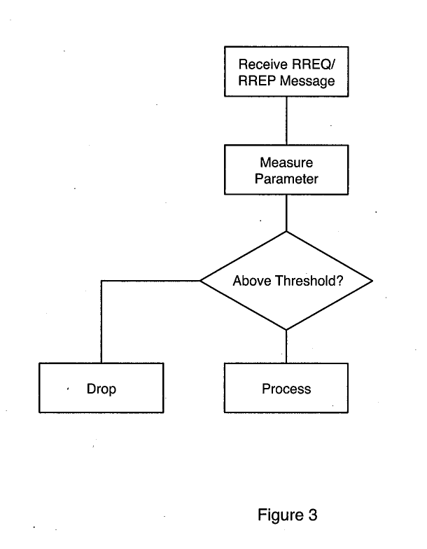

FIG. 3 shows the decision making flow 301 to 305 when receiving an AODV message. In step 301, the RREQ/RREP message is received. In step 302, a parameter of the received message that is indicative of signal quality is measured. In step 303, a decision is made whether the parameter is above a threshold. If the measure is below the threshold, the message is dropped (step 305). If the measure is above the threshold, the message is processed in conventional fashion (step 304).

Another system configuration message that may be used is the HELLO packet, which may be periodically sent out by a node to notify other nodes of the existence of the node. Normally, neighbor nodes use these packets to update their routing tables. The threshold technique may be used with HELLO packets to measure link quality to the transmitting node, and to decide to drop that node from the routing table. In this case, AODV has the RERR message, which can be used to trigger a new route discovery. The flow in FIG. 3 also applies to the reception of HELLO messages and RREP-ACK messages.

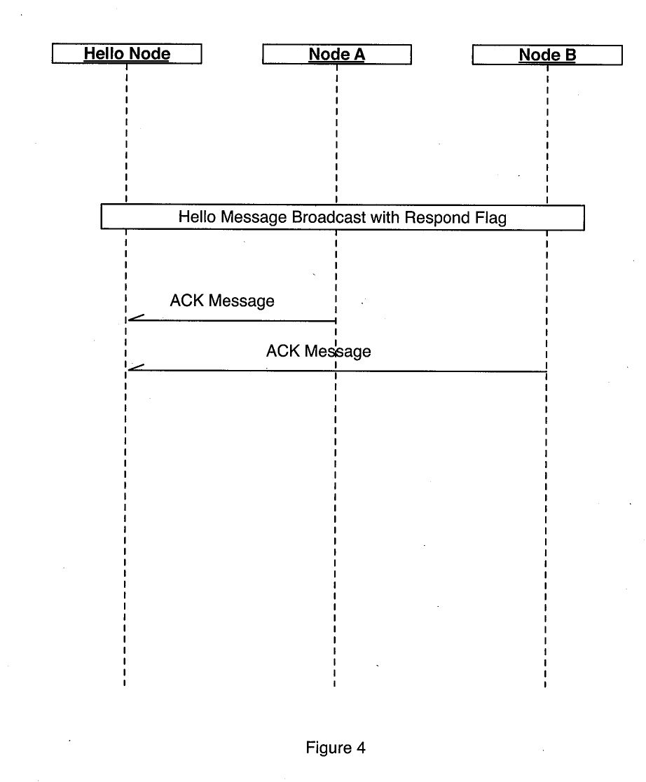

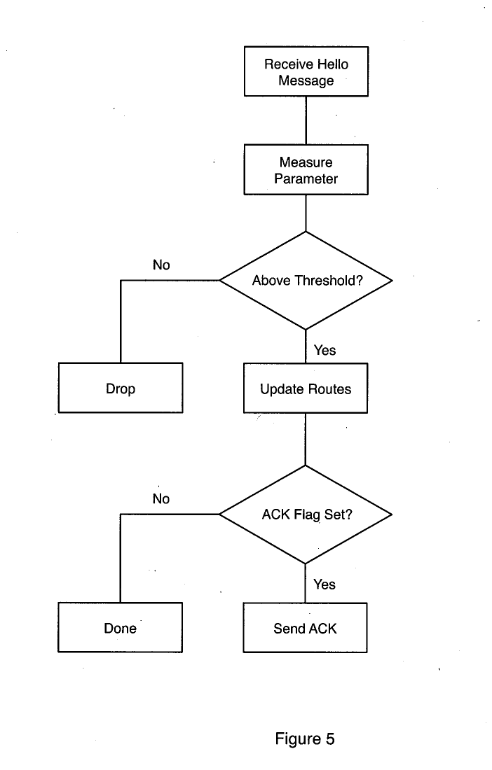

FIG. 4 shows the message sequence 401 to 406 for the HELLO/ACK message exchange. Three nodes are assumed to be in the network: a hello node 401 that initiates a HELLO message, and node A (402) and node B (403), which are other nodes in the AODV network. The node 401 broadcasts a HELLO message with a respond flag at step 406. When a node such as node A or node B receives the HELLO message, it responds with an ACK message (404, 405). FIG. 5 shows the decision mechanism 501 to 508 for receiving a HELLO message with and without the “ACK” flag set. Step 501: receive HELLO message at a node. Step 502: measure a signal quality parameter. Step 503: decide if the signal quality parameter is above a threshold. Step 504: If the signal quality parameter is below a threshold, drop the HELLO message. Step 505: if the signal quality parameter is above a threshold, update a routing table to include the route followed by the HELLO message. Step 506: determine whether an ACK flag is set. Step 507, if not, no further step required. Step 508: if an ACK flag is set, send an ACK message.

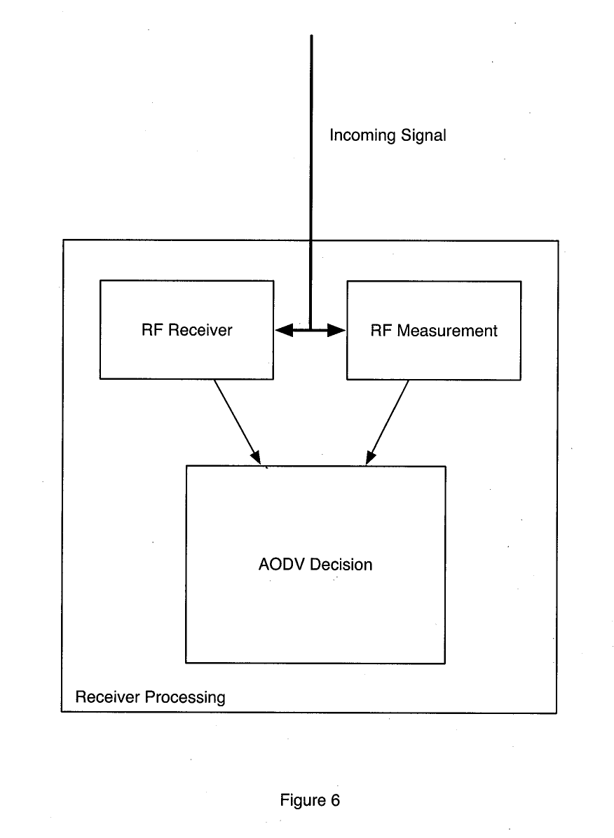

FIG. 6 shows a receiver apparatus 605 required for carrying out at least some embodiments of the method disclosed here. The RF receiver 602 receives and decodes the RF signal 601, passing it to upper layers 604 that include the AODV stack. The RF measurement block 603 provides measurements like RSSI, CINR, etc. to the higher layers 604 so that the AODV mechanism can determine whether to use or discard an incoming AODV message.

Applicability

Wireless sensor arrays deployed in a mesh or client-server network using AODV as a route discovery mechanism.

Extensibility

This technique may use static, semi-static, or dynamic thresholds, or combinations of these modes.

Static Configuration

Static thresholds may be pre-set for the device. For example, one may determine (by calculation or experiment) that a given fade margin is required for acceptable operation. In this case, the incoming signal quality is determined (using any one or combination of known channel measurement parameters) and the measurement is compared to the threshold to determine whether to accept or drop an RREQ message. This parameter may be adjustable, but is pre-configured for (for example) a given topology, operating environment, network configuration, or other parameter.

Semi-Static Configuration

In some cases, the network deployment may be one that requires adjustment of the threshold parameter in the field. In this case, the parameter may be adjusted by sending a message to the node or manually indicating a change thorough some other means. For example, the operator may send a message to a node to switch the threshold parameter from SINR to RSSI, along with a new threshold value, or the operator may indicate that a new combination of measurements shall be used to determine link quality.

Dynamic Configuration

Nodes may autonomously re-configure threshold values or parameters based on the operating environment. For example, if a node is deployed and several other nodes are within radio range, then the deployed node may adjust thresholds and/or measurement parameters to reduce the amount of traffic it passes. For example, the node may raise the required SINR threshold so that only very strong signals are accepted. If, later, the node detects fewer nodes within range, it may lower the threshold to ensure more complete connectivity to the network. The node may also adjust thresholds based on current load. For example, if the node is passing a lot of traffic to a lot of neighbor nodes, it may raise the threshold to force others to take some of the load (load balancing). Another example is if a node cannot detect any neighbors within range that meet or exceed the threshold value, it may lower the threshold to allow for some control signaling.

Hybrid (Static/Dynamic) Thresholds

There are cases where a dynamic node may be required to accept connections from a given node, or the operator may want to override some parameters related to dynamic adjustment. In this case, messages or other means may be used to alter some threshold parameters, while others remain “dynamic” and under control of the node itself. For example, the operator may force a node to use a specific measurement (e.g. RSSI) for threshold detection, but allow the node to adjust the threshold value dynamically.

Message Enhancements

The HELLO message may be used to initiate a message similar to the RREP-ACK, where neighbor nodes respond the HELLO message, allowing the node to update its own routing tables as well as providing a transmission for others to measure. This may be accomplished by modifying the structure of the HELLO message, or by creating a new message extension. For this example, a node transmits a HELLO message with a flag requesting an acknowledgement. Upon receiving this message, each node in the area updates its tables (based on whether the HELLO message met threshold requirements), and then responds to the HELLO message so the originating node can measure transmission values and update its tables. A random timing back-off value may be used to ensure that the nodes sending acknowledgements do not transmit at the same time.

To establishing a route with acceptable signal quality in a wireless mesh network, the following steps may be carried out. A first node transmits a message requesting a route connecting to a second node, a route request, for example a HELLO broadcast. The route request message may be a direct transmission from the first node or a retransmission from another node. At a node at which the route request is detected, determine from which node the route request message was received at the node, determine whether the signal quality of the route request message is above a threshold and retransmit the route request message if the signal quality was determined in the previous step to be above the threshold, and drop the route request message if the signal quality was determined in the previous step not to be above the threshold. The second node receives the route request message and transmits to the first note a reply message. On detecting at the second node the route request message, the second node sends a reply message indicating that a route has been found to the node from which the route request message was received at the second node. This step is then repeated until a reply message is received at the first node indicating that a route has been found to the first node. At the node from which the route request message was received at the second node, if that node is not the first node, a reply message is transmitted indicating that a route has been found to the node from which the route request message was received at that node.

An alternative embodiment follows.

Current System

In the existing system, a single threshold value is stored. The threshold is represented by a value between 0 and 255 (inclusive).

Operation

If the reported RSSI value associated with any AODV management packet (e.g. RREQ, RREP, RERR, RREP-ACK, HELLO, or other user-defined AODV extension messages) is below the stored threshold value, that AODV packet is dropped. If the reported RSSI value associated with any AODV management packet is above the threshold value, the AODV packet is processed normally.

New Hysteresis Triggers

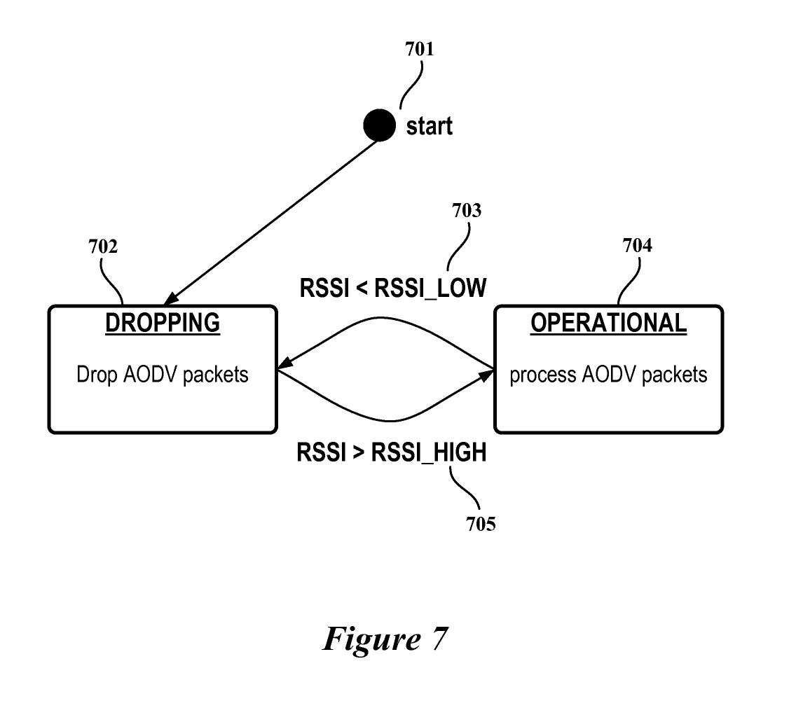

The new work requires two threshold values: RSSI_LOW and RSSI_HIGH, to create a hysteresis to prevent instability in the system. Also required is a state machine for each known neighbor device (FIG. 7). The states are “operational” and “dropping.” The system initially assumes DROPPING state for each device. Only identifiers for devices in OPERATIONAL state need be stored.

When an AODV packet is received from a device in DROPPING mode and that packet has an RSSI value greater than the RSSI_HIGH threshold, that device status is switched to OPERATIONAL and packets (including the one just received) from the transmitting device are processed.

When an AODV packet is received from a device in OPERATIONAL state, and that packet has an RSSI less than the RSSI_LOW threshold, that device status is switched DROPPING and packets (including the one just received) from the transmitting device are dropped.

State Descriptions

OPERATIONAL State. All AODV management packets are processed normally. If an AODV management packet is received with an RSSI value below the RSSI_LOW value, the packet is dropped and the state machine for that device is switched to “DROPPING” state.

DROPPING State. All AODV management packets are dropped. If an AODV management packet is received with an RSSI value above the RSSI_HIGH value, the packet is processed normally and the state machine for that device is switched to “OPERATIONAL” state.

FIG. 7 shows a state machine 701 to 705 for a device. The states are OPERATIONAL 704 and DROPPING 702. The system initially assumes DROPPING state for each device 701.

The state machine for each device need only consist of the IP address of that device, and only the IP addresses of devices in the OPERATIONAL state need to be stored in memory. If a limit is required, assume a maximum of 256 state machines will be required, and, if practical, allow that value to be field configurable. Do not use memory space for a state machine for a device in DROPPED state.

If memory use is a serious concern, a hash function may be used to store a representative value of the IP address (or some other identifier) of any devices in range but in an OPERATIONAL state. If you implement a hash function, the hash must be unique for devices in a Class B subnet (so it may be as simple as storing the low 2 bytes of the IP address). This could save 2 bytes of memory per device in OPERATIONAL state.

States are not stored between re-boots. Threshold values shall be retained between re-boots.

Comparing the instantaneous RSSI value of a certain link to a pre-set threshold, to determine the status of that link in a wireless mesh network, can result with many unstable links and hence very inefficient network. The instantaneous RSSI value fluctuates causing each link to repeatedly jump between PROCESSING and DROPPING states. Introducing the hysteresis algorithm provides some stability, but still not enough to provide a stable link that is preferable for a wireless mesh network. The RSSI value needs to be filtered in order to avoid costly and unnecessary link status changes. It was found that the hysteresis and filtering together provided the stability needed for an efficient wireless mesh network.

Various smoothing or low pass filters may be used such as Averaging, Median, and Scoring Filters. They all have been found to give good results, and the higher the number of taps, the more stable the link status.

For the Averaging Filter, each node saves a number of RSSI readings equals to the number of taps of the filter for each link it can see, then arithmetically averages them and uses the average to decide the status of each link. After each received packet the filter process runs, then the history of the RSSI readings gets updated and waits for the next packet.

For the Median Filter, each node does exactly the same as for the Averaging Filter case except for it uses the median of the saved RSSI readings instead of the arithmetic average.

As the number of filter taps gets higher, the implementation of Averaging and/or Median filters becomes very complicated and the implementation memory and processing requirements get higher and potentially unaffordable depending on the network especially that each node needs to implement separate filter for each node it can see even if at very low RSSI or signal quality. The Scoring Filter implementation helps stabilize the link status and eliminated the extra memory and processing load increase with the higher number of taps.

The main goal from the filtering and hysteresis algorithms is to provide links that are stable at either PROCESSING or DROPPING states. Jumping around from one state to another proved very costly to the network efficiency.

The response of the Scoring Filter implementation is very similar to the response of the Median Filter with more desirable bias toward the steady state status of each link. Opposite to the Averaging and Median Filter where history of previous RSSI readings need to be saved in memory, the Scoring Filter implementation does not require saving any history and has very little processing requirement, which does not increase with higher number of taps.

The filter may be contained in the receiver processing unit 605, and may be implemented by any suitable method including using software implemented by a processor.

Immaterial changes may be made to the embodiments disclosed without departing from what is claimed.

1. A method of improving signal quality in an ad hoc on-demand distance vector (AODV) mesh network, comprising:
detecting at a node the signal quality of a received AODV protocol message;
comparing the signal quality of the received AODV protocol message to a threshold; and
on detecting that the signal quality of the received AODV message is not above the threshold, dropping the received AODV message.

2. The method of claim 1 further comprising the step of modifying a routing table at the node based on the results of the step of comparing the signal quality of the received AODV protocol message to the threshold.

3. The method of claim 1 in which the received AODV protocol message is an RREQ message.

4. The method of claim 1 in which the received AODV protocol message is an RREP message.

5. The method of claim 1 in which the received AODV protocol message is a HELLO message.

6. The method of claim 1 in which the received AODV protocol message is a HELLO ACK message.

7. The method of claim 1 in which the method of detecting signal quality at a node comprises at measuring at least one of input signal-to-noise ratio, noise-plus-interference ratio, carrier-to-noise-plus-interference ratio or received signal strength indicator.

8. The method of claim 1 in which the method of detecting signal quality at a node comprises detecting the modulation or coding scheme selected by the transmitting device.

9. In an ad hoc on-demand distance vector (AODV) mesh, an improvement comprising:
detecting at a node the signal quality of the RREQ messages receive at that node; and dropping any RREQ messages for which the signal quality is not above a threshold.

10. The method of claim 1 further comprising applying a smoothing or low pass filter to the detected signal quality before comparing the signal quality of the received AODV protocol message to a threshold.

11. A method of establishing a route with acceptable signal quality in a wireless mesh network, comprising:
transmitting at a first node a route request message, wherein the route request message requests a route connecting to a second node;
carrying out at least at a node at which the request message is detected the steps of:
determining from which node the route request message was received at the node;
determining whether the signal quality of the route request is above a threshold; and
retransmitting the route request message if the signal quality was determined in the previous step to be above the threshold, and dropping the route request message if the signal quality was determined in the previous step not to be above the threshold;
receiving at the second node the route request message;
transmitting a reply message from the second node to the first node;
on detecting at the second node the route request message with, sending a reply message indicating that a route has been found to the node from which the route request message was received at the second node;
at the node from which the route request message was received at the second node, if that node is not the first node, retransmitting the reply message indicating that a route has been found to the node from which the route request message was received at that node; and
repeating the previous step until the reply message indicating that a route has been found is received at the first node.

12. The method of claim 11 also comprising the steps of:
determining at a node receiving the reply message indicating that a route has been found whether the signal quality of the reply message indicating that a route has been found is above a threshold; and
if the signal quality of the reply message indicating that a route has been found is not above the threshold, dropping the reply message.

13. The method of claim 11 further comprising applying a smoothing or low pass filter to the signal quality before comparing the signal quality of the message requesting a route to a threshold.

14. A method of establishing routing tables for improving signal quality in a wireless mesh network, comprising:
transmitting a message from a first node;
detecting and measuring the signal quality of the message at a second node;
comparing the signal quality of the message to a threshold; and
updating a routing table at the second node so that the routing table includes the first node as a neighbor node only if the signal quality of the message is above the threshold.

15. The method of claim 14 also comprising:
in response to detecting the message from the first node at the second node, transmitting a reply message from the second node to the first node;
detecting and measuring the signal quality of the reply message at the first node;
comparing the signal quality of the reply message to a threshold; and
updating a routing table at the first node so that the routing table includes the second node as a neighbor node only if the signal quality of the message is above the threshold.

16. The method of claim 14 further comprising applying a smoothing or low pass filter to the signal quality of the message before comparing the signal quality of the message to a threshold.

17. A method of improving signal quality in a wireless mesh network, comprising establishing routes between nodes of the wireless mesh network using only links between pairs of nodes in which the routing tables of each node of the pair of nodes has a routing table established by the method of claim 12 which includes the other node of the pair of nodes as a neighbor node.

18. The method of claim 1 further comprising the step of adjusting the threshold at a node in response to a message received at the node indicating that the threshold should be adjusted.

19. A method of improving signal quality in a wireless mesh network, comprising:
detecting at a first node a signal quality of a transmission from a second node;
comparing the signal quality of the transmission to a threshold; and
allowing the link between the first node and the second node to be used in a route only if the signal quality is above the threshold, in which the threshold is varied at the first node depending on at least one of A) the number of other nodes the signal quality from which has been detected at the first node to be above the threshold, and B) the load transmitted by the first node.

20. The method of claim 19 further comprising adjusting the variance of the threshold at a node in response to a message received at the node indicating that the variance of the threshold should be adjusted.

21. The method of claim 19 further comprising applying a smoothing or low pass filter to the signal quality of the transmission before comparing the signal quality of the transmission to a threshold.
